(19) United States
(12) Patent Application Publication
(10) Pub. No.: US 2005/0013948 A1
(43) Pub. Date: Jan. 20, 2005

(54) Ink jet recording sheet

(76) Inventor: Hirotaka Yamamoto, Shizuoka (JP)

Correspondence Address: SMITH PATENT OFFICE, 1901 PENNSYLVANIA AVENUE N W, SUITE 200, WASHINGTON, DC, 20006, US

(21) Appl. No.: 10/884,168

(22) Filed: Jul. 6, 2004

(30) Foreign Application Priority Data
Jul. 7, 2003 (JP) 2003-192747

(51) Int. Cl. B41M 5/00

(52) U.S. Cl. 428/32.34

(57) ABSTRACT

There is provided an ink jet recording sheet comprising a substrate and an ink accepting layer formed on at least one surface of the substrate which comprises a silica-containing filler, a binder and a cationic resin, wherein said silica contained in the filler satisfies (a) an average particle size of 10 μm or larger as measured by Coulter counter method; (b) a particle size distribution d10/d90 of 0.13 or higher; and (c) a pore volume of 1.6 to 2.2 mL/g, and a content of the cationic resin in the ink accepting layer is in the range of 1 to 9% by weight in terms of a solid content therein. The ink jet recording sheet of the present invention, even if the substrate is made of a plastic film, can completely absorbing a large amount of injected ink for a short period of time, and can be printed at a high speed.

### FIELD OF THE INVENTION

The present invention relates to an ink jet recording sheet, and more particularly to an ink jet recording sheet suitable for printing high-quality images at a high speed.

### RELATED ARTS

Hitherto, ink jet recording sheets have been required to have a good ink absorption property.

Namely, if the recording sheets fail to rapidly absorb ink after printing, there will occur problems on printed images such as bleeding, beading and deterioration in color development. In addition, when the printed surface of the recording sheets comes into contact with a back surface thereof upon taking-up into a roll or stacking together after printing, there will also occur problems such as defective printed images and set-off of ink.

Further, a good ink absorption of the recording sheets is more remarkably required upon high-speed printing. The higher-speed printing tends to not only make the above problems on printed images more remarkable, but also cause the following problems. That is, in the ink jet printing method in which band-like printing regions corresponding to reciprocating motion of a print head are sequentially formed in the direction of transportation of the recording sheet in an adjacent relation to each other, ink droplets injected are attached onto the recording sheet and slightly spread thereover during formation of the respective printing regions. In this case, if a band-like printing region is formed before ink attached to the previous adjacent printing region is sufficiently absorbed, slight spread of the ink attached thereto tends to cause undesired bleeding in the form of streaks at a boundary between the adjacent printing regions. As the printing speed becomes higher, the adjacent printing regions are formed at shorter time intervals and, therefore, a more rapid absorption of ink is required. Further, at the high-speed printing, a larger number of printed cut sheets must be stacked together for a shorter time, and a printed elongated continuous sheet must also be taken up into a roll for a shorter time. Therefore, even though ink is absorbed in these recording sheets to such an extent as to prevent bleeding of ink, the resultant printed images tend to still suffer from set-off of ink upon application of pressure owing to the stacking and taking-up.

Moreover, with the improvement in printing image quality due to enhanced performance of a printer, there is such a tendency that an amount of ink jetted increases. More specifically, in current technologies, when the area of individual ink dots is reduced and the number thereof is increased in order to enhance the resolution of printed images, there is such a tendency that a total amount of ink jetted increases. In addition, there is a recent tendency that the number of ink dots is increased for the purpose of expressing delicate color nuance, which results in further increase in amount of ink jetted.

Thus, in order to meet requirements imposed by recent progress of printer performance for improving quality of printed images, the recording sheets have also been required to have a more excellent ink absorption property.

In many of ink jet recording sheets, an ink accepting layer tends to be formed on a substrate thereof, or the substrate tends to be surface-treated. The substrate is frequently made of not a paper but a plastic film in view of strength, water resistance and prevention of cockling.

However, when the substrate is made of not a paper but a plastic film, it tends to be more difficult to allow the ink jet recording sheets to show a good ink absorption property. For this reason, it has been especially required to develop technologies for improving an ink absorption property of such ink jet recording sheets using a plastic film as the substrate.

The printers of an ink jet recording type are usually capable of changing-over a printing mode by setting of a soft ware thereof. Although some conventional printers are settable to a high-speed/high-quality printing mode, there have been recently marketed many printers capable of printing images at a much higher speed while maintaining a high image quality thereof. Some of these printers can produce printed images having a practical resolution of 720×720 dpi at a speed as high as 6 to 8 min/m².

However, the above ink jet recording sheets using a plastic film as the substrate thereof tend to be still insufficient in ink absorption property. Therefore, it is required to develop ink jet recording sheets capable of permitting these high-speed printers to exhibit their optimum performance.

In order to improve an ink absorption property of the recording sheets, there have been conventionally proposed the following methods. That is, in the case of ink jet recording sheets that usually have an ink accepting layer composed of a filler and a binder, there have been proposed the methods in which the filler and the binder are used in the ink accepting layer at a specific blending ratio, or the filler having a large particle size is used therein (for example, refer to Japanese Patent Application Laid-open No. 2001-301313). However, these methods have problems such as deteriorated strength of the ink accepting layer.

In addition, there have been proposed the techniques using a filler having a large pore volume. However, only use of such a filler is insufficient to improve the ink absorption property of the recording sheets. Besides, since the filler having a large pore volume tends to have a large particle size, the resultant ink accepting layer tends to be deteriorated in strength.

Further, the ink jet recording sheets have been required to have anti-silvering property (property of preventing occurrence of so-called “silvering” effect), scratch-abrasion resistance under wet conditions of the ink accepting layer, color development, anti-bleeding property of images, water resistance of images, etc. However, the conventional recording sheets fail to satisfy all of these requirements at the same time.

Meanwhile, the “silvering” used herein means such a phenomenon that when the recording sheet is covered with a plastic film after printing for the purpose of protecting the printed surface thereof, the covered printed images look dark and dull. This phenomenon is caused by inclusion of air between the ink accepting layer and the plastic film, and tends to more frequently occur when the filler having a large particle size is used in the ink accepting layer. In addition, such a phenomenon tends to occur more remarkably at black-printed image portions.

### SUMMARY OF THE INVENTION

An object of the present invention is to solve the above conventional problems and provide an ink jet recording sheet that is suitable for printing high-quality images at a high speed and is excellent in ink absorption property, strength of an ink accepting layer, anti-silvering property, scratch-abrasion resistance under wet conditions of the ink accepting layer, color development, anti-bleeding property of images, water resistance of images, etc.

As the result of extensive researches and studies in view of the above object, the present inventors have found that the above object is achieved by such an ink jet recording sheet whose ink accepting layer includes a filler containing silica having specific properties and further a specific amount of a cationic resin. The present invention has been accomplished on the basis of this finding.

Thus, the present invention provides:
(1) an ink jet recording sheet comprising:
a substrate; and
an ink accepting layer formed on at least one surface of the substrate which comprises a silica-containing filler, a binder and a cationic resin,
said silica contained in the filler satisfying the following requirements (a) to (c):
(a) an average particle size of 10 μm or larger as measured by Coulter counter method;
(b) a particle size distribution d10/d90 of 0.13 or higher; and
(c) a pore volume of 1.6 to 2.2 mL/g, and
a content of the cationic resin in the ink accepting layer being in the range of 1 to 9% by weight in terms of a solid content therein;
(2) the ink jet recording sheet according to the above aspect (1), wherein a content of the silica in the filler is 75% by weight or higher;
(3) the ink jet recording sheet according to the above aspect (1) or (2), wherein the binder comprises silanol-modified polyvinyl alcohol;
(4) the ink jet recording sheet according to any of the above aspects (1) to (3), wherein the cationic resin comprises at least one resin selected from the group consisting of dicyandiamide condensates, polymers of dimethylamine and epichlorohydrin, polyallylamine and copolymers of diallylamine and allylamine;
(5) the ink jet recording sheet according to any of the above aspects (1) to (4), wherein the ink accepting layer further comprises a hydrated aluminum oxide; and
(6) the ink jet recording sheet according to any of the above aspects (1) to (5), wherein the ink accepting layer further comprises a water-soluble aluminum salt.

### DETAILED DESCRIPTION OF THE INVENTION

The ink jet recording sheet of the present invention includes a substrate and an ink accepting layer formed on at least one surface of the substrate.

In the present invention, any sheet-like material may be used as the substrate without any particular limitations. Examples of the substrate include known sheet materials conventionally used for this purpose such as papers, plastic films and nonwoven fabrics. Of these substrates, plastic films are preferred in view of good water resistance thereof.

Examples of materials of the plastic films include thermoplastic resins ordinarily used for this purpose such as polyvinyl chloride, polyethylene terephthalate, polypropylene, polystyrene and polycarbonates, resin compositions prepared by blending inorganic particles such as calcium carbonate into these polymers, or resin compositions prepared by blending organic pigments to these polymers.

In addition, as the substrate, there may also be used films made of biodegradable plastic materials.

Further, foamed plastic films may also be used as the substrate. The “foamed plastic films” used herein mean such plastic films having cracks or deficiencies formed on a surface or inside of the films, or fine bubbles or voids. Among them, as the foamed plastic films having bubbles or voids, there may be used microvoid films produced by stretching films containing inorganic particles such as calcium carbonate to thereby form bubbles or voids around the individual inorganic particles, films that are foamed using a foaming agent, etc., irrespective of their names, production methods and configuration of the bubbles or voids.

Meanwhile, the plastic films used herein also include so-called synthetic papers.

The substrate may have a single layer structure or a multilayer structure. The substrate having a multilayer structure may be produced by any known methods, for example, a method of laminating respective layers through an adhesive, a so-called co-extrusion method in which a plurality of raw materials are extruded from a plurality of extruders and merged into a multilayer film, a so-called extrusion laminating method in which a film is directly extruded and laminated onto another film material, etc.

One or both surfaces of the substrate may be subjected to various surface treatments by oxidation method or irregularity-forming method in order to improve an adhesion to the ink accepting layer, a wettability, etc. Examples of the oxidation method include corona discharge treatment method, hot-air treatment method or the like. Examples of the irregularity-forming method include sandblast method, solvent treatment method or the like. These surface treatments are selectively used according to a kind of the substrate to be treated. In general, the corona discharge treatment method is preferably used in view of the effects and facilitated operation.

In the ink jet recording sheet of the present invention, the ink accepting layer that is formed on at least one surface of the substrate, includes, in addition to the binder and a specific amount of the cationic resin, the filler containing silica having specific properties.

The silica having specific properties (hereinafter sometimes referred to as “specific silica”) means such a silica satisfying the following three requirements (a) to (c):
(a) an average particle size of 10 μm or larger as measured by Coulter counter method;
(b) a particle size distribution d10/d90 of 0.13 or higher; and
(c) a pore volume of 1.6 to 2.2 mL/g.

The average particle size as measured by Coulter counter method, the particle size distribution d10/d90 and the pore volume have the following definitions and are measured by the following methods.

(a) The average particle size as measured by Coulter counter method means an average value of secondary particle sizes of the silica.

(b) The particle size distribution d10/d90 is defined as a ratio of the maximum particle size d10 given when a cumulative volume of particles sequentially accumulated from the smallest size particle reaches 10% of a total volume of particles, to the maximum particle size d90 given when a cumulative volume of particles sequentially accumulated from the smallest size particle reaches 90% of a total volume of particles.

(c) The pore volume is measured by mercury penetration method.

When the average particle size of the silica as measured by Coulter counter method is less than 10 μm, the resultant ink accepting layer tends to be deteriorated in ink absorption property. The average particle size of the silica as measured by Coulter counter method is preferably 10 to 15 μm and more preferably 12.0 to 13.5 μm. The silica having an average particle size of 15 μm or lower tends to readily provide those silica particles capable of satisfying the above requirements.

When the particle size distribution d10/d90 is less than 0.13, the resultant recording sheet tends to be deteriorated in anti-silvering property. The particle size distribution d10/d90 is preferably 0.13 to 1.00 and more preferably 0.135 to 1.00.

When the pore volume is less than 1.6 mL/g, the resultant ink accepting layer tends to be deteriorated in ink absorption property. When the pore volume exceeds 2.2 mL/g, the resultant ink accepting layer tends to be deteriorated in color development. The pore volume is preferably 1.7 to 2.1 mL/g.

The silica is preferably of a gel type produced by a wet method.

The ink accepting layer may also contain, in addition to the specific silica, a filler other than the specific silica. The content of the specific silica in the whole filler is preferably 75% by weight or higher and more preferably 90% by weight or higher. The higher content of the specific silica in the whole filler leads to a more excellent ink absorption property of the resultant ink accepting layer.

As the filler other than the specific silica, any of organic and inorganic substances may be used without particular limitations. Examples of the filler other than the specific silica include calcium carbonate, talc, clay, diatomaceous earth, polystyrene, polymethacrylate, titanium oxide, baked kaolin, hydrous magnesium silicate or the like. These fillers may be used singly or in the form of a mixture of any two or more thereof.

The content of the specific silica in the ink accepting layer formed on at least one surface of the substrate is 55 to 65% by weight and preferably 57 to 62% by weight in terms of a solid content therein. When the content of the specific silica is less than the above-specified range, the resultant ink accepting layer tends to be deteriorated in ink absorption property. On the contrary, when the content of the specific silica exceeds the above-specified range, the ink accepting layer tends to be deteriorated in strength.

Examples of the binder used in the ink accepting layer include polyvinyl alcohol, polyvinyl butyral, gelatin, polyvinyl acetal, carboxymethyl cellulose, polyvinyl pyrrolidone, polyesters, acrylic polymers, polyurethanes, chlorinated polypropylene, homopolymers or copolymers of vinyl versatate, styrene-acrylic copolymers, ethylene-vinyl acetate copolymers, styrene-butadiene rubbers, etc. Of these binders, silanol-modified polyvinyl alcohols are preferred in view of enhanced strength of the resultant ink accepting layer.

These binders may be used singly or in combination of any two or more thereof.

The content of the binder in the ink accepting layer is 20 to 35% by weight and more preferably 25 to 33% by weight in terms of a solid content therein. When the binder content is less than the above-specified range, the resultant ink accepting layer tends to be deteriorated in strength. On the contrary, when the binder content exceeds the above-specified range, the resultant ink accepting layer tends to be deteriorated in ink absorption property.

Examples of the cationic resin contained in the ink accepting layer include various resins capable of forming water-insoluble salts by reacting with sulfone groups or carboxyl groups of dyes or coloring pigments used for ink jet printing, and cationic resins containing secondary amines, tertiary amines, quaternary ammonium salts, etc. Specific examples of the cationic resin include polyethylene imine, polyvinyl pyridine, polyvinyl amine, polymers of (meth)acrylamide alkyl quaternary ammonium salts, dicyandiamide condensates, polymers of secondary amine and epichlorohydrin, polyepoxyamine, polydimethyldiallylammonium chloride, polyallylamine, copolymers of diallylamine and allylamine, copolymers of (meth)acrylamide and diallylamine, epichlorohydrin polyamide, polydialkylaminoethyl acrylamide, dicyandiamide polyethyleneamine, polydimethylamineammonium epichlorohydrin, etc.

Of these cationic resins, more preferred is at least one resin selected from the group consisting of dicyandiamide condensates, polymers of dimethylamine and epichlorohydrin, polyallylamine and copolymers of diallylamine and allylamine.

More preferably, the above preferred cationic resin may be used together with polydiallylamine in order to enhance a light resistance of the resultant ink accepting layer.

Meanwhile, the polyallylamine, polydiallylamine and copolymers of diallylamine and allylamine are suitably used in the form of a water-soluble salt thereof in view of good handling property.

In the present invention, the content of the cationic resin in the ink accepting layer is required to fall within the range of 1 to 9% by weight in terms of a solid content therein. When the content of the cationic resin is less than 1% by weight, the resultant ink accepting layer tends to suffer from bleeding of ink images printed thereon. On the contrary, when the content of the cationic resin exceeds 9% by weight, the resultant ink accepting layer tends to be deteriorated in ink absorption property. The content of the cationic resin in the ink accepting layer is preferably 3 to 8% by weight and more preferably 5 to 7% by weight.

The ink accepting layer may further contain, in addition to the above filler, binder and cationic resin, a hydrated aluminum oxide and/or a water-soluble aluminum salt such as aluminum lactate and aluminum sulfate to improve the color development as well as the scratch-abrasion resistance under wet conditions of the ink accepting layer.

The content of each of the hydrated aluminum oxide and the water-soluble aluminum salt in the ink accepting layer is preferably 0.5 to 8% by weight in terms of a solid content therein.

Further, the ink accepting layer may contain, if desired, various additives such as defoamers, antistatic agents, ultraviolet absorbers, fluorescent brightener, antiseptic agents, pigment dispersants and thickening agents, unless the addition of these additives adversely affects the effects of the present invention.

The thickness of the ink accepting layer after drying is preferably 30 to 50 nm and more preferably 35 to 45 μm. When the thickness of the ink accepting layer is less than 30 μm, the resultant ink accepting layer tends to be deteriorated in ink absorption property. On the contrary, when the thickness of the ink accepting layer exceeds 50 μm, the resultant ink accepting layer tends to be deteriorated in strength.

In the ink jet recording sheet of the present invention, as described in the above aspect (1), at least one ink accepting layer containing the silica having specific properties, the binder and a specific amount of the cationic resin (hereinafter occasionally referred merely as “ink accepting layer of the present invention”) is formed on at least one surface of the substrate. Thus, the ink accepting layer of the present invention may be formed on one or both surfaces of the substrate, and the two or more ink accepting layers may be formed on one surface of the substrate. For example, when the two ink accepting layers are laminated together on one surface of the substrate such that a total thickness of the two layers is equal to the thickness of the single ink accepting layer, the thus-formed laminated ink accepting layer tends to be prevented from cracking.

Further, the ink accepting layer of the present invention may be used in combination with the other kind of ink accepting layer. For example, another ink accepting layer having no adverse influence on the effects of the ink accepting layer of the present invention may be further provided in combination therewith. In one exemplary case, an ink accepting layer containing titanium oxide as a filler may be formed between the substrate and the ink accepting layer of the present invention to enhance a hiding power of the resultant ink jet recording sheet. In addition, the other ink accepting layer may be formed on a surface of the ink jet recording sheet opposite to the surface where the ink accepting layer of the present invention is provided.

Further, the ink jet recording sheet of the present invention may also include various layers other than the ink accepting layer, for example, such as an anchor coat layer for enhancing the adhesion between the ink accepting layer and the substrate, a high-opacity layer for enhancing a hiding power thereof, an ultraviolet absorbing layer and an anti-curl layer.

The ink accepting layer and the other optional layers provided in the ink jet recording sheet of the present invention may be formed by applying a coating solution prepared by dispersing or dissolving necessary components and then drying the applied solution. The application of the coating solution may be performed by various known methods such as reverse roll coating, air knife coating, gravure coating and blade coating.

The present invention will be described in more detail below with reference to the following examples and comparative examples. However, these examples are only illustrative and not intended to limit the invention thereto.

[Production of Ink Jet Recording Sheet]

### EXAMPLE 1

A 80 μm-thick white foamed polypropylene film (microvoid film “YUPO FPG#80” available from Yupo Corp.) was used as a substrate.

As an anchor coat layer coating solution, there was used a uniform mixture containing the following components:

| | |
|---|---|
| (a) Acrylic resin (tradename “ACRONAL | 60 parts by weight |
| YJ-6221D” available from BASF | |
| Dispersions Co., Ltd.; solid content: | |
| 49 wt %; anionic resin) | |
| (b) Calcium carbonate (tradename “CAL. | 10 parts by weight; and |
| LIGHT-SA” available from Shiraishi | |
| Central Laboratories Co., Ltd.; solid | |
| content: 100 wt %; aragonite type) | |
| (c) Water | 30 parts by weight. |

As an ink accepting layer coating solution, there was used a uniform
mixture containing the following components:

| | |
|---|---|
| (1) Filler: Silica (tradename “GASIL HP395” marketed from Wilbur | 20.6 parts by weight; |
| Ellis Co.,Ltd.; solid content: 100 wt %; average particle size as measured by | |
| Coulter counter method: 12.5 to 13.0 μm; particle size distribution d10/d90: | |
| 0.139; pore volume: 1.80 mL/g) | |
| (2) Binder: Silanol-modified polyvinyl alcohol (tradename “KURARAY | 10.3 parts by weight; |
| R POLYMER R-1130” available from Kuraray Co., ltd.; solid content: 100 wt %) | |
| (3) Cationic resin: Mixture of polydiallylamine and polyallylamine | 12.23 parts by weight; |
| (tradename “NEOFIX RX-100” available from Nicca Chemical Co., Ltd.; solid | |
| content: 19 wt %; an aqueous solution containing a mixture of a | |
| polydiallylamine salt and a polyallylamine salt) | |
| The content of the cationic resin was 6.8% by weight in terms of a solid | |
| content in the ink accepting layer. | |
| (4) Surfactant (tradename “OLFIN STG” available from Nissin | 0.45 part by weight; |
| Chemical Industry, Co., Ltd.; solid content: 85 wt %) | |
| (5) Defoamer (tradename “SN - Defoamer 480” available from San | 0.35 part by weight; |
| Nopco Ltd.; solid content: 100 wt %) | |
| (6) Fluorescent brightener (tradename “BLANKOPHOR UW Liquid” | 0.15 part by weight and |
| available from Bayer AG; solid content: 100 wt %) | |
| (7) Water | 161.4 parts by weight. |

The anchor coat layer coating solution was applied on one surface of the substrate and then dried to form an anchor coat layer having a thickness of 5 μm (after drying). Then, the ink accepting layer coating solution was applied onto the thus formed anchor coat layer and then dried to form an ink accepting layer having a thickness of 40 μm (after drying), thereby producing an ink jet recording sheet.

### EXAMPLE 2

The same procedure as in EXAMPLE 1 was repeated except for adding the following additives to the ink accepting layer coating solution, thereby producing an ink jet recording sheet.

Additives Added

| | |
|---|---|
| Hydrated aluminum oxide (tradename | 13.9 parts by weight |
| “ALUMINA SOL 200” available from Nissan | |
| Chemical Industries, Ltd.; solid content: 10 wt %) | |
| Basic aluminum lactate (tradename | 2.00 parts by weight |
| “TAKICERAM M-160L” available from Taki | |
| Chemical, Co., Ltd.; solid content: 25 wt %) | |

The content of the cationic resin was 6.5% by weight in terms of a solid content in the ink accepting layer.

### EXAMPLE 3

The same procedure as in EXAMPLE 1 was repeated except for changing the filler in the ink accepting layer coating solution from “GASIL HP395” to the following silica, and further adding 13.9 parts by weight of the hydrated aluminum oxide (tradename “ALUMINA SOL 200” available from Nissan Chemical Industries, Ltd.; solid content: 10 wt %) to the ink accepting layer coating solution, thereby producing an ink jet recording sheet.

Filler Used

| | |
|---|---|
| Silica (tradename “SYLO JET P416” marketed | 20.6 parts by weight |
| from Grace Japan, Inc.; solid content: 100 wt %; | |
| average particle size as measured by Coulter counter | |
| method: 12.0 μm; particle size distribution d10/d90: | |
| 0.152; pore volume: 2.05 mL/g) | |

The content of the cationic resin was 6.5% by weight in terms of a solid content in the ink accepting layer.

### COMPARATIVE EXAMPLE 1

The same procedure as in EXAMPLE 2 was repeated except for changing the filler in the ink accepting layer coating solution from “GASIL HP395” to the following silica, thereby producing an ink jet recording sheet.

Filler Used

| | |
|---|---|
| Silica (tradename “MIZUKASIL P-78A” available | 20.6 parts by weight |
| from Mizusawa Industrial Chemicals Ltd. Japan.; | |
| solid content: 100 wt %; average particle size as | |
| measured by Coulter counter method: 3.3 μm; | |
| particle size distribution d10/d90: 0.358; pore | |
| volume: 1.60 mL/g) | |

The content of the cationic resin was 6.5% by weight in terms of a solid content in the ink accepting layer.

### COMPARATIVE EXAMPLE 2

The same procedure as in EXAMPLE 2 was repeated except for changing the filler in the ink accepting layer coating solution from “GASIL HP395” to the following silica, thereby producing an ink jet recording sheet.

Filler Used

| | |
|---|---|
| Silica (tradename “MIZUKASIL P-78F” available | 20.6 parts by weight |
| from Mizusawa Chemical Industries, Co., Ltd. | |
| Japan.; solid content: 100 wt %; average particle | |
| size as measured by Coulter counter method: | |
| 12.5 μm; particle size distribution d10/d90: | |
| 0.117; pore volume: 1.65 mL/g) | |

### COMPARATIVE EXAMPLE 3

The same procedure as in EXAMPLE 2 was repeated except for changing the filler in the ink accepting layer coating solution from “GASIL HP395” to the following silica, thereby producing an ink jet recording sheet.

Filler Used

| | |
|---|---|
| Silica (tradename “SYLYSIA 470” available | 20.6 parts by weight |
| from Fuji Silysia Chemical Co., Ltd.; solid content: | |
| 100 wt %; average particle size as measured | |
| by Coulter counter method: 12.0 μm; particle | |
| size distribution d10/d90: 0.144; pore volume: | |
| 1.25 mL/g) weight | |

### COMPARATIVE EXAMPLE 4

The same procedure as in EXAMPLE 2 was repeated except for changing the amount of the cationic resin used in the ink accepting layer coating solution from 12.23 parts by weight to 23.00 parts by weight, thereby producing an ink jet recording sheet.

The content of the cationic resin was 11.5% by weight in terms of a solid content in the ink accepting layer.

[Evaluation Using High-Speed Type Printer]

The properties of the ink jet recording sheet were evaluated according to the following procedure. Also, the printed images were evaluated as follows. That is, images were printed with a genuine aqueous pigment type ink using a high-quality high-speed printer “JV4-180” available from Mimaki Engineering Co., Ltd. More specifically, a rolled paper having a width of 914 mm as the ink jet recording sheet was taken off, printed at a speed of 10 min/m² and then wound up into a roll at a distance of 400 mm from a print head of the printer.

(1) Ink Absorption Property

Color inks used: cyan, magenta, yellow, black, light cyan and light magenta
Printed images: black solid printed with a mixture of whole color inks (720×720 dpi)
Output conditions: printing speed: Normal; normal dots; unidirectional 8 pass image printing

After printing, the obtained print was visually observed and was examined whether any of (1) abnormality of printed images (in particular, bleeding at overlapped portions of the printed images, etc.) and (2) set-off (transfer of a part of ink printed on the recording sheet to a back surface thereof when the sheet was wound up into a roll) occurred or not. The results were classified into the following ratings.
A: No abnormality on the printed images and no set-off of ink occurred
B: Either abnormality on the printed images or set-off of ink occurred.
   (2) Scratch-Abrasion Resistance Under Wet Conditions

The surface of the ink accepting layer was rubbed with a sufficiently wet cotton bar so as to impose a load of 100 g thereonto until any part of the ink accepting layer was released off the recording sheet. The number of rubbing times up to occurrence of the release of the ink accepting layer was examined by counting one reciprocating rubbing motion as one time in which one way length was about 50 mm.

(3) Strength of Ink Accepting Layer

A cellophane tape (“CT405A-18” available from Nichiban Co., Ltd.; length: 10 cm) was attached onto the ink accepting layer by reciprocating a 2-kg pressure roller three times, and peeled off in a reverse direction at an angle of 45° to examine a degree of release of the ink accepting layer together with the tape. The results were classified into the following ratings.
A: Area of the ink accepting layer released as being attached onto the cellophane tape was 30% or lower;
B: Area of the ink accepting layer released as being attached onto the cellophane tape was more than 30% but 60% or lower; and
C: Area of the ink accepting layer released as being attached onto the cellophane tape was more than 60%.
   (4) Color Development
Color inks used: cyan, magenta, yellow, black, light cyan and light magenta
Printed images: a single color solid of each of cyan, magenta, yellow and black which were prepared by mixing appropriate inks.
Output conditions: printing speed: Normal; normal dots; unidirectional 8 pass image printing

The degree of color development after printing was visually observed. The results were classified into the following ratings.
A: Extremely excellent color development
B: Good color development
C: Poor color development
   (5) Anti-Bleeding Property, etc.

Color inks used: cyan, magenta, yellow, black, light cyan and light magenta
Printed images: portrait
Output conditions: printing speed: Normal; normal dots; unidirectional 8 pass image printing

The printed images were visually observed. The results were classified into the following ratings.
A: Free from bleeding, beading, feathering and collapse
B: Suffer from any of bleeding, beading, feathering and collapse
   (6) Anti-Silvering Property
Color inks used: cyan, magenta, yellow, black, light cyan and light magenta
Printed images: a single color solid of each of cyan, magenta, yellow and black which were prepared by mixing appropriate inks.
Output conditions: printing speed: Normal; normal dots; unidirectional 8 pass image printing

After printing, a laminated film (PET laminated film “G03EV50C” available from Sakurai Co., Ltd.) was attached onto a 25 mm-width adherend to be tested using a laminator, and allowed to stand in an atmosphere of 23° C. and 50% RH for 24 hours.

Thereafter, the degree of anti-silvering property of the printed images was visually observed. The results were classified into the following ratings.
A: Less inclusion of air between the ink accepting layer and the laminated film, and clear printed images; and
B: Significant inclusion of air between the ink accepting layer and the laminated film, and dark and dull printed images.
   (7) Water Resistance of Images (Dropping)
Color inks used: cyan, magenta, yellow, black, light cyan and light magenta
Printed images: a single color solid of each of cyan, magenta, yellow and black which were prepared by mixing appropriate inks.
Output conditions: printing speed: Normal; normal dots; unidirectional 8 pass image printing

Five minutes after completion of the printing, one droplet of distilled water was dropped on the printed image portion. At the time at which the distilled water was completely absorbed, the degree of ink runoff was visually observed. The results were classified into the following ratings.
A: No runoff
B: Significant runoff

The respective ink jet recording sheets obtained in Examples 1 to 3 and Comparative Examples 1 to 4 were examined as to (1) ink absorption property, (2) scratch-abrasion resistance under wet conditions, (3) strength of the ink accepting layer, (4) color development, (5) anti-bleeding property, (6) anti-silvering property and (7) water resistance of printed images, when images were printed thereon using a high-speed type printer. The evaluation results are shown in Table 1.

TABLE 1-1

| Examples | | Scratch-abrasion | | |
|---|---|---|---|---|
| and | Ink | resistance | Strength of | |
| Comparative | absorption | under wet | ink accepting | Color |
| Examples | property | conditions | layer | development |
| Example 1 | A | 20 | A | B |
| Example 2 | A | 35 | A | A |
| Example 3 | A | 32 | A | A |
| Comparative | B | 30 | C | A |
| Example 1 | | | | |
| Comparative | B | 25 | B | A |
| Example 2 | | | | |
| Comparative | B | 45 | A | C |
| Example 3 | | | | |
| Comparative | B | 15 | B | A |
| Example 4 | | | | |

TABLE 1-2

| Examples and | | Anti- | Water |
|---|---|---|---|
| Comparative | Anti-bleeding | silvering | resistance |
| Examples | property, etc. | property | of images |
| Example 1 | A | A | A |
| Example 2 | A | A | A |
| Example 3 | A | A | A |
| Comparative | B | A | A |
| Example 1 | | | |
| Comparative | B | B | A |
| Example 2 | | | |
| Comparative | B | A | A |
| Example 3 | | | |
| Comparative | B | A | B |
| Example 4 | | | |

[Evaluation of Ink Absorption Property Using an Ordinary Printer]

The ink jet recording sheets obtained in the above Examples and Comparative Examples were printed by injecting a large amount of ink using a printer of not a high-speed type but an ordinary type to evaluate an ink absorption property of the respective sheets according to the following procedure.
Printer used: Ink jet printer of a pigment type “MC9000” available from Seiko Epson Corporation.
Color inks used: cyan, magenta, yellow, black, light cyan and light magenta (all were genuine inks of an aqueous pigment type)
Printed images: black solid printed with a mixture of whole color inks.
Setting of printer: 100% injection for each color of CMYK; ink injection amount: 400%; matted synthetic paper 2-mode

The printing operation was controlled such that an injection amount of ink was 20 g/m².

Ninety seconds after completion of the printing, the printed image portions of the respective sheets were rubbed with fingers to visually examine whether or not any defective printed images due to spread of ink dots occurred. If no defective printed images occurred, the recording sheets were examined about whether or not there was any wet feeling or touch. The results were classified into the following ratings and are shown in Table 2.
A: No defective printed images, and no wet feeling or touch
B: No defective printed images, but some wet feeling or touch
C: Slight defective printed images which was practically acceptable

D: Defective printed images which were practically unacceptable

TABLE 2

| Examples | Ink absorption |
|---|---|
| and Comparative Examples | property |
| Example 1 | A |
| Example 2 | A |
| Example 3 | A |
| Comparative Example 1 | C |
| Comparative Example 2 | B |
| Comparative Example 3 | D |
| Comparative Example 4 | D |

The ink jet recording sheet of the present invention includes a substrate and an ink accepting layer formed on the substrate which contains a filler containing silica having specific properties and a specific amount of a cationic resin, and is excellent in high-speed/high-quality printability, ink absorption property, strength of ink accepting layer, anti-silvering property, scratch-abrasion resistance under wet conditions of the ink accepting layer, color development, anti-bleeding property of images, and water resistance of images.

In particular, even when the substrate is made of a plastic film and ink is injected in an amount as large as 20 g/m², the ink jet recording sheet of the present invention exhibit an excellent ink absorption capable of completely absorbing such a large amount of ink within 90 seconds. Accordingly, the ink jet recording sheet of the present invention, even if the substrate is made of a plastic film, is capable of printing images thereon at a high speed close to the maximum printing capacity of a high-speed type printer, so that it becomes possible to produce a large number of prints for a shorter period of time.

1. An ink jet recording sheet comprising:
a substrate; and
an ink accepting layer formed on at least one surface of the substrate which comprises a silica-containing filler, a binder and a cationic resin, said silica contained in the filler satisfying the following requirements (a) to (c):
(a) an average particle size of 10 μm or larger as measured by Coulter counter method;
(b) a particle size distribution d10/d90 of 0.13 or higher; and
(c) a pore volume of 1.6 to 2.2 mL/g,
a content of the cationic resin in the ink accepting layer being in the range of 1 to 9% by weight in terms of a solid content therein.

2. The ink jet recording sheet according to claim 1, wherein a content of the silica in the filler is 75% by weight or higher.

3. The ink jet recording sheet according to claim 1, wherein the binder comprises silanol-modified polyvinyl alcohol.

4. The ink jet recording sheet according to claim 2, wherein the binder comprises silanol-modified polyvinyl alcohol.

5. The ink jet recording sheet according to claim 1, wherein the cationic resin comprises at least one resin selected from the group consisting of dicyandiamide condensates, polymers of dimethylamine and epichlorohydrin, polyallylamine and copolymers of diallylamine and allylamine.

6. The ink jet recording sheet according to claim 2, wherein the cationic resin comprises at least one resin selected from the group consisting of dicyandiamide condensates, polymers of dimethylamine and epichlorohydrin, polyallylamine and copolymers of diallylamine and allylamine.

7. The ink jet recording sheet according to claim 3, wherein the cationic resin comprises at least one resin selected from the group consisting of dicyandiamide condensates, polymers of dimethylamine and epichlorohydrin, polyallylamine and copolymers of diallylamine and allylamine.

8. The ink jet recording sheet according to claim 4, wherein the cationic resin comprises at least one resin selected from the group consisting of dicyandiamide condensates, polymers of dimethylamine and epichlorohydrin, polyallylamine and copolymers of diallylamine and allylamine.

9. The ink jet recording sheet according to claim 1, wherein the ink accepting layer further comprises a hydrated aluminum oxide and/or a water-soluble aluminum salt.

10. The ink jet recording sheet according to claim 2, wherein the ink accepting layer further comprises a hydrated aluminum oxide and/or a water-soluble aluminum salt.

11. The ink jet recording sheet according to claim 3, wherein the ink accepting layer further comprises a hydrated aluminum oxide and/or a water-soluble aluminum salt.

12. The ink jet recording sheet according to claim 4, wherein the ink accepting layer further comprises a hydrated aluminum oxide and/or a water-soluble aluminum salt.

13. The ink jet recording sheet according to claim 5, wherein the ink accepting layer further comprises a hydrated aluminum oxide and/or a water-soluble aluminum salt.

14. The ink jet recording sheet according to claim 6, wherein the ink accepting layer further comprises a hydrated aluminum oxide and/or a water-soluble aluminum salt.

15. The ink jet recording sheet according to claim 7, wherein the ink accepting layer further comprises a hydrated aluminum oxide and/or a water-soluble aluminum salt.

16. The ink jet recording sheet according to claim 8, wherein the ink accepting layer further comprises a hydrated aluminum oxide and/or a water-soluble aluminum salt.
